(19) United States
(12) Patent Application Publication
(10) Pub. No.: US 2013/0262175 A1
(43) Pub. Date: Oct. 3, 2013

(54) RANKING OF JOBS AND JOB APPLICANTS

(71) Applicants: Sandeep Suresh Deshpande, Pune (IN); Peter A. Stacholy, Playa Del Rey, CA (US); Indivar Nayyar, Ghaziabad (IN); Ajay Gachhi, Bangalore (IN); Rakesh Patel, Himatnagar (IN); Prashant Kishore Biswal, Cuttak (IN); Rajagopal Poosala, Jagtial (IN); Arnab Naskar, Kolkata (IN); Rohit Balakrishna, Bangalore (IN); Sushant Kumar, Dhenkanal (IN)

(72) Inventors: Sandeep Suresh Deshpande, Pune (IN); Peter A. Stacholy, Playa Del Rey, CA (US); Indivar Nayyar, Ghaziabad (IN); Ajay Gachhi, Bangalore (IN); Rakesh Patel, Himatnagar (IN); Prashant Kishore Biswal, Cuttak (IN); Rajagopal Poosala, Jagtial (IN); Arnab Naskar, Kolkata (IN); Rohit Balakrishna, Bangalore (IN); Sushant Kumar, Dhenkanal (IN)

(73) Assignee: Infosys Limited, Bangalore (IN)

(21) Appl. No.: 13/492,696

(22) Filed: Jun. 8, 2012

(30) Foreign Application Priority Data
Mar. 29, 2012 (IN) 1209/CHE/2012

(51) Int. Cl. G06Q 10/06

(52) U.S. Cl. 705/7.25

(57) ABSTRACT

A ranking system ranks applicants for a job. Eligible applicants are selected from a pool of applicants and are ranked based on business rules applied to information about the eligible applicants and information about the job. Scores are calculated for the business rules based on how well the applicant information matches the job information in areas such job skills, educational background, availability and pay. Additional information such as whether an employer or applicant does not wish to work together, and staffing firm expenses associated with eligible applicants can also be considered in the ranking process. The business rules can be weighted to achieve various ranking objectives, such as increasing staffing firm revenue or awarding higher rankings to applicants whose skills and educational background better match an employer's needs. The ranking system can also be used to rank jobs for an applicant.

### BACKGROUND

Staffing firms depend on being able to provide high-quality matches to applicant and employers in order to attract and retain clients. Even if the pool of applicants a staffing firm has its disposal is large, and there are a large number of job positions to fill, staffing professionals need to be able to make these matches efficiently and effectively. Staffing professionals can be aided in the matching process by a front office staffing system.

### SUMMARY

This Summary is provided to introduce a selection of concepts, in a simplified form, that are further described hereafter in the Detailed Description. This Summary is not intended to identify key features or essential features of the claimed subject matter nor is it intended to be used to limit the scope of the claimed subject matter.

Ranking systems and methods are disclosed that rank applicants for a job. In one embodiment, eligible applicants are selected from a pool of applicants based on a match between information about the job and information about the applicants. Information about an applicant can include the applicant's desired pay rate, the applicant's skill set and educational background, when the applicant is available to work, whether the applicant does not wish to work with certain employers, and the like. Information about the job can include the pay rate offered by the employer, the day the job starts, the skill set and educational background the employer is looking for in applicants, which applicants, if any, the employer is not willing to hire, and the like. Additional information such as whether an applicant has or is currently collecting unemployment insurance or workers' compensation can be included in the applicant or job information.

The eligible applicants are ranked based on business rules that assign scores to various parameters, such as job skills, educational background, job pay and when the job is available, based on the applicant information, and the job information. Scores are calculated for the eligible applicants and the eligible applicants are ranked according to the calculated scores. The eligible applicants are then presented to staffing firm personnel in ranked order. In some embodiments, eligible applicants can be selected, ranked and presented to staffing firm personnel in real time. In various embodiments, feedback can be provided to an applicant or an employer offering a job to improve the ranking of the applicant or the job. The feedback can include suggestions on which parameters the applicant or employer should change to improve their rankings.

In some embodiments, the selection of eligible applicants is performed by a front office staffing system and the ranking of eligible applicants is performed by a decision making tool. A rank request is sent from the front office staffing system to the decision making tool requesting that eligible applicants indicated in the rank request be ranked. After ranking the applicants, the decision making tool responds with ranking information for the applicants. In various embodiments, the front office staffing system and the decision making tool comprise the PeopleSoft® software and Real Time Decision (RTD) Platform provided by Oracle®, respectively.

In another embodiment, jobs can be ranked for an applicant. Eligible jobs can be selected based on matches between information about the various jobs and applicant information. Scores are calculated for the eligible jobs, the eligible jobs are ranked according to the calculated scores, and the ranked jobs are presented to staffing firm personnel.

The foregoing and other objects, features, and advantages of the technologies disclosed herein will become more apparent from the following detailed description, which proceeds with reference to the accompanying figures.

### BRIEF DESCRIPTION OF THE DRAWINGS

FIG. 1 is a block diagram of an exemplary ranking system for ranking applicants for a job.

FIG. 2 is a block diagram of exemplary job information.

FIG. 3 is a block diagram of exemplary applicant information.

FIG. 4 is a block diagram of an exemplary business rules database.

FIG. 5 is a flowchart of an exemplary method of ranking applicants for a job.

FIG. 6 is a flowchart of additional exemplary actions that can comprise the ranking action of the method illustrated in FIG. 2.

FIG. 7 is a flowchart of an exemplary method of ranking jobs for an applicant.

FIG. 8 is an exemplary ranking system utilizing the PeopleSoft® software and Real Time Decision platform provided by Oracle®.

FIG. 9 illustrates a generalized example of a suitable computing environment in which described embodiments, techniques, and technologies can be implemented.

FIG. 10 illustrates a generalized example of a suitable implementation environment in which described embodiments, techniques, and technologies can be implemented.

### DETAILED DESCRIPTION

Technologies for ranking applicants for a job are disclosed. Eligible job applicants are selected from a pool of applicants and the eligible job applicants are ranked based on scores that are determined by applying business rules to information about the applicants (applicant information) and information about the job (job information). The business rules have associated weights, which can be configured to achieve various desired objectives. A front office staffing system can collect applicant information and job information, and select eligible applicants from an applicant database. A decision making tool can determine the scores for the eligible applicants and rank the eligible applicants for the job.

### Example 1

### Exemplary Ranking System

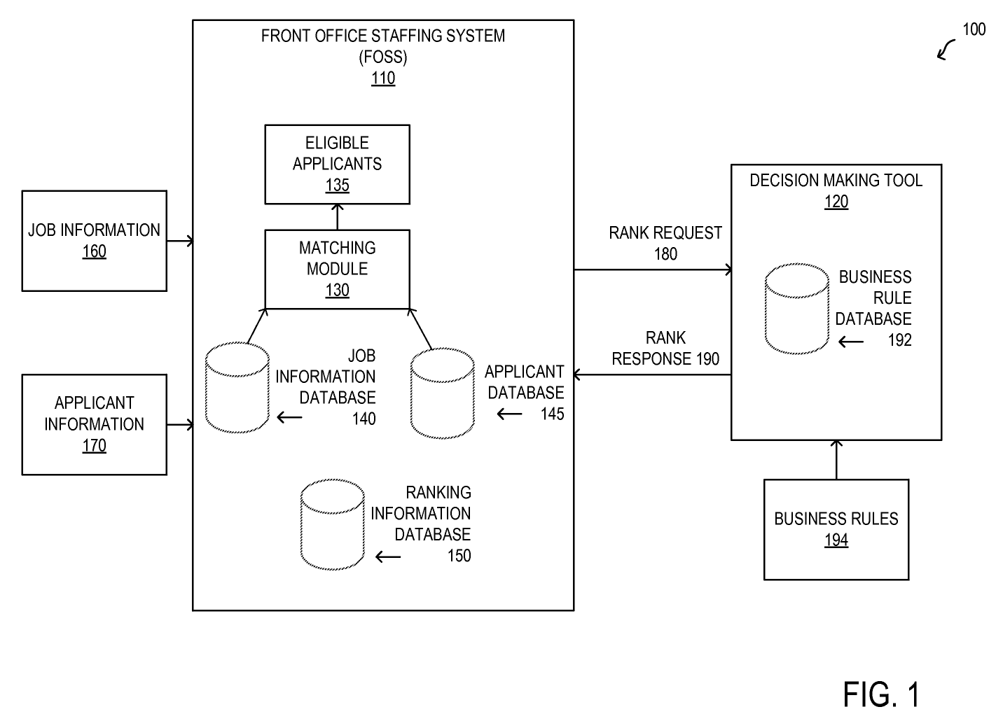

FIG. 1 shows an exemplary ranking system 100 for ranking applicants for a job. The ranking system 100, which is typically implemented as a computer system, comprises a front office staffing system 110 and a decision making tool 120. The front office staffing system 110 comprises a matching module 130, a job information database 140, an applicant database 145 and a ranking information database 150.

The front office staffing system (FOSS) 110 is any system capable of performing tasks related to matching job applicants with job openings. These tasks include, for example, receipt and processing of applicant resumes and job openings, management of applicant information and job information databases, selection and ranking of eligible applicants for a job, and presentation of applicants in ranked order to staffing firm personnel. One example of a FOSS is the PeopleSoft® software offered by Oracle®. The FOSS 110 receives job information 160 and applicant information 170, which the FOSS 110 uses to create entries in the job information database 140 and the applicant database 145, respectively. The matching module 130 is configured to select eligible applicants 135 for a job, send a request to the decision making tool 120 to rank the eligible applicants 135 (rank request 180), receive a response from the decision making tool 120 containing ranking information for the eligible applicants 135 (rank response 190), and present a ranked list of the eligible applicants 135 at an output device of the FOSS 110 (not shown).

The decision making tool 120 comprises a business rules database 192. The decision making tool 120 is configured to receive a rank request 180 and rank eligible applicants 135 for a job based on job information, applicant information about the eligible applicants 135 and business rules stored in the business rule database 192. The decision making tool 120 is typically further configured to calculate scores for the eligible applicants 135 as part of the ranking and to rank the eligible applicants 135 based at least in part on the calculated scores. As part of the applicant ranking process, the decision making tool 120 generates ranking information indicating the ranking of the eligible applicants. The rank response 190 comprises ranking information generated by the decision making tool 120.

The job information 160 and applicant information 170 can be received at the FOSS 110 via an FOSS integration with job portals or by input device (e.g., keyboard), a web page, from another computer system or in any other manner. The business rules 194 can be received at the decision making tool 120 in any similar manner. The databases 140, 145, 150 and 192 can be internal to the FOSS 110 or the decision making tool 120, an external device connected to the FOSS 110 or decision making tool 120, or located remotely, such as in cloud-based storage.

In any of examples described herein, the matching module 130 determines eligible applicants 135 for a job based on applicant information and job information corresponding to the job stored in databases 140 and 145. The matching module 130 can determine eligible applicants 135 automatically upon receipt of job information 160 for a new job opening, upon request by an operator of the system 100 (e.g., staffing firm personnel) or in response to any other request received or generated by the FOSS 110.

The rank request 180 comprises applicant information for the eligible applicants 135 for a job (eligible applicant information), and job information corresponding to the job for which eligible applicants are to be matched (target job information). The eligible applicant information can comprise all or a portion of the applicant information stored in the applicant database 145 for the eligible applicants, and the target job information can contain all or a portion of the job information stored in the job information database 140 corresponding to the target job. In some embodiments, a rank request 180 can request that eligible applicants be ranked for more than one job, and comprise applicant information and job information for more than one job. The rank response can then include ranking information for multiple jobs.

In one embodiment of the system 100, the FOSS 110 comprises PeopleSoft® software provided by Oracle® and the decision making tool 120 comprises Oracle®'s Real-Time Decisions (RTD) platform.

### Example 2

### Job Information Database

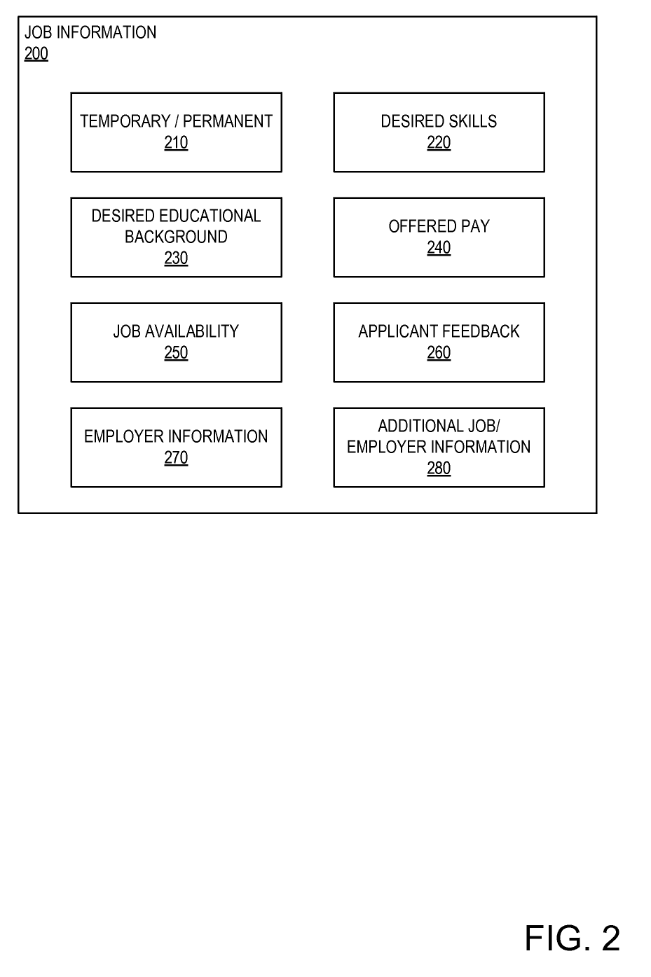

FIG. 2 shows exemplary job information 200 for a job for which eligible applicants are to be determined and ranked. The job information 200 can be provided to an FOSS as job information 160 and stored as an entry in a job information database 140. Job information 200 can contain the following job information parameters:
Temporary/permanent information 210 indicating whether the job is a temporary or permanent position.
Desired skills information 220 indicating the job skills, competencies or experience (job skills) that an applicant should possess. One or more job skills can be included in the desired skills information 220 for a job. For a particular job skill, the desired skills information 220 can comprise one or more of the following: a description of the job skill (e.g., database design, software engineer), the importance that the applicant possess the skill (e.g., necessary, desired, optional), the number of years of experience the applicant has in practicing the skill, the applicant's proficiency in the skill (e.g., expert, very good, good, fair) and the like.
Desired educational background information 230 indicating the degree(s) that an applicant should have. For a particular degree, the desired educational background information 230 can include one or more of the following: a description of the degree (e.g., Bachelor of Computer Science, Bachelor of Science), the importance that an applicant possesses the degree (e.g., necessary, desired, optional), a description of the major (e.g., computer science, management information system) and the like.
Offered pay information 240 indicating how much a staffing company is offering to pay an applicant to perform the job (pay rate). The offered pay information 240 can also contain the rate that the staffing firm bills an employer for providing an applicant (bill rate). The pay rate can be a single value or a range of values and can indicate a salary (e.g., annual, monthly, weekly), per unit pay, or other wage amount. In some embodiments, the offered pay information 240 can comprise variable pay information if an employer is willing to offer different levels of pay to applicants with different levels of qualifications. For example, if an employer is willing to offer more money to an applicant with more experience or an advanced degree in a particular field, the offered pay information 240 for the job can include fixed pay rate information for lesser qualified applicants and offered pay rate information for more qualified applicants. The offered pay rate can be determined automatically by a ranking system 100 based on the bill rate. For example, the pay rate can be a fixed dollar amount or a percentage below the pay rate provided by an employer.
Job availability information 250 indicating when the job is available. Job availability information can comprise a start date and, optionally, an end date.
Applicant feedback information 260 indicating whether an employer is willing to work with particular applicant. In some embodiments, applicant feedback information could be included in the applicant information for an applicant who an employer does not wish to hire.
Employer information 270 indicating information about the employer such as employer identifying information (employer/customer ID), employer contact information, employer payment information (such as whether the employer is current on his payments to the staffing company, the amount of delinquent bills due, how long the bills have been due and the like).
Additional information 280, which can include information such as job-specific information (e.g., a job order number), travel requirements for the job (e.g., what percentage of the job involves travel), whether there are opportunities for promotion, whether signing bonuses, stock options, health insurance, relocation services or any other benefits are available.

While job information 200 generally comprises information corresponding to a particular job, and is typically based on job information 160 received by an FOSS 110, the job information 160 can comprise job information for more than one job. For example, an employer can submit a single job order comprising multiple jobs to the staffing firm for filling. The FOSS 110 can be configured to generate multiple job information entries from a single job order (i.e., a single set of job information 160).

Job information 200 can include more or less information than that shown in FIG. 2. For example, job information 200 may not include employer information 270 or applicant feedback 260, which could be stored in, for example, an employer database. However, such information could still be supplied in a rank request 180. For example, a FOSS 110 could comprise an employer database that contains applicant feedback information indicating which applicants an employer does not wish to hire, and that information can be included in a rank request 190. This information can be part of job information 200 for a job, or it can be associated with a given employer, as an employer may not want to hire a particular applicant regardless of the job they are seeking to fill. This information can be included as part of applicant information for an applicant as well. That is, as employers indicate which applicants they do not wish to hire, this information can be added to the applicant information for the indicated applicants.

### Example 3

### Applicant Database

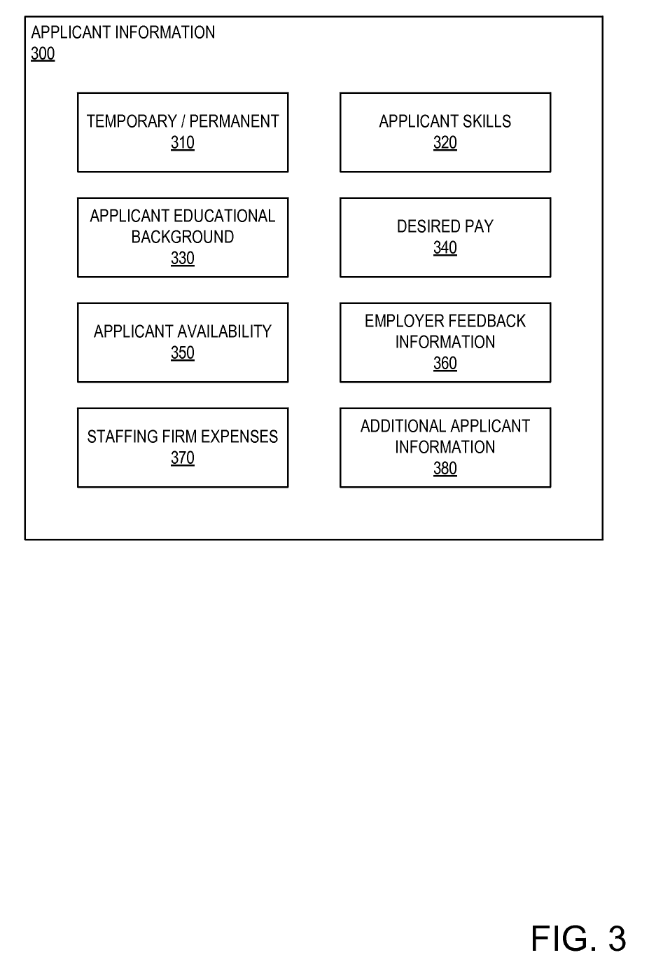

FIG. 3 shows exemplary applicant information 300 for an applicant. Applicant information 300 can contain the following applicant information parameters:
Temporary/permanent information 310 indicating whether an applicant is interested in temporary and/or permanent positions.
Applicant skills information 320 indicating the skills that an applicant possesses. One or more skills can be included in applicant skills information 320. For an individual skill, the applicant skills information 320 can comprise one or more of the following: a description of the skill, the year the skill was acquired, the year the skill was last used, the number of years of experience the applicant has in practicing the skill, the applicant's proficiency in the skill (e.g., expert, very good, good, fair), and the like.
Applicant educational background information 330 indicating the degree(s) that an applicant has. For an individual degree, the educational background information 330 can include one or more of the following: a description of the degree (e.g., Bachelor of Computer Science), the institution granting the degree, the date of graduation, grade point average and the like.
Desired pay information 340 indicates a pay rate that an applicant is willing to accept. The pay information can be a single value or a range of values and can indicate a salary (e.g., annual, monthly, weekly), per unit pay, or a fixed amount for performing the job.
Applicant availability information 350 indicating when the applicant is available to work. Applicant availability information 350 can comprise, for example, the day the applicant is available to start working, the last day the applicant is available to work, the desired minimum or maximum duration of a work assignment, and the like. The availability information can also indicate whether the applicant is currently employed.
Employer feedback information 360 indicating whether an applicant is willing to be employed by particular employers.
Staffing firm expenses information 370 indicating staffing firm expenses associated with an applicant. These expenses can include workers' compensation payments and unemployment insurance payments. Thus, the staffing firm expenses information 370 can comprise workers' compensation information comprising, for example, workers' compensation previously paid and/or owed to an applicant, the amount of workers' compensation being paid to an applicant on a monthly or other periodic basis, whether the applicant has ever collected workers' compensation before, and the like. The staffing firm expenses information 370 can also include unemployment insurance information comprising similar information for unemployment insurance payments (e.g., whether the applicant has previously received unemployment insurance payments, unemployment payments already paid out, the amount of periodic unemployment insurance payment, etc.)
Additional applicant information 380, which can include information such as the applicant's name, contact information, whether the applicant has been matched with the employer previously, whether the applicant is willing to relocate (including specific geographic regions to which the applicant is willing to relocate), language skills, how many day's or weeks' notice the applicant needs to give their present employer before leaving to start a new job, how much travel the applicant is willing to do as part of the job, desired benefits (such as signing bonus, stock options, health insurance, relocation reimbursement, education reimbursement) and the like. The additional applicant information 380 can also include text provided by the applicant to supply additional information to the staffing firm.

Although applicant information is generally provided by an applicant, applicant information can be updated by a staffing firm in response to various events such as the completion of a job assignment. Applicants can update their applicant information as well, for example, as they develop new skills, earn degrees, their availability changes, to change their pay expectations to increase the chance of being selected for a job, or to be more selective.

### Example 4

### Exemplary Determination of Eligible Applicants

In any of the examples described herein, a ranking system can select eligible applicants from an applicant database for ranking for a particular job in order to avoid having to rank all applicants in an applicant database. Eligible applicants are selected from an applicant database based on matches between applicant information and job information for a particular job. Eligible applicants can be selected on matches between any number of parameters and on any degree of matching between parameters. For example, eligible applicants can be selected based on matches between educational background, availability, skills or pay parameters, or any combination thereof. Eligible applicants can be selected if indicated parameters match exactly or within a specified range.

If a large number of applicants are selected as eligible applicants, a ranking system can be configured to add additional filters to the eligible applicant search to limit the number of eligible applicants passed to a decision making tool. For example, consider the situation where an FOSS configured to select eligible applicants based on the educational background identifies 200 eligible applicants. If the ranking system is configured to limit the number of eligible applicants in a rank request to, for example, 20, the FOSS can add a second constraint to the applicant database search, such as pay rate or job skills. The FOSS can continue to increase the number of constraints in an applicant database search until fewer than 20 eligible applicants are selected.

In some embodiments, the eligible candidate search is performed using broad applicant parameter(s) to increase the likelihood that a diverse group of applicants is selected for ranking. For example, the FOSS can search for eligible applicants using the degree parameter and search for all applicants that have, for example, a Bachelor of Science degree, rather than a narrower parameter such as a particular job skill. If the search yields too many candidates, increasingly narrower parameters (such as particular job skills) can be added to the search.

### Example 5

### Exemplary Business Rules

In any of the examples described herein, eligible applicants can be ranked using business rules. Generally, a business rule is associated with one job information/applicant information parameter (e.g., educational background, skills) and the business rule is applied to the associated applicant information and job information to determine a score for that particular business rule. A business rule can be implemented as an algorithm that accepts the applicant information parameter and job information parameter associated with the rule as inputs. For example, a skills business rule can determine a skills score for an eligible applicant by determining how well the number of years of experience an employer wants an applicant to have for a particular skill matches the number of years of experience an applicant has in performing that skill. The closer the match between the two, the greater the score. The business rules scores for an eligible applicant are summed up to determine a score for the eligible applicant. Typically, the eligible applicants are then ranked based on the eligible candidate scores.

The business rules can be stored in a business rules database (such as business rule database 192). All or fewer than all of the business rules in a business rule database can be used in ranking eligible applicants. Business rules to be used in ranking eligible applicants can be determined through configuration of the decision making tool or based on information contained in a rank request. For example, a rank request can contain information indicating which business rules are to be used in ranking eligible applicants.

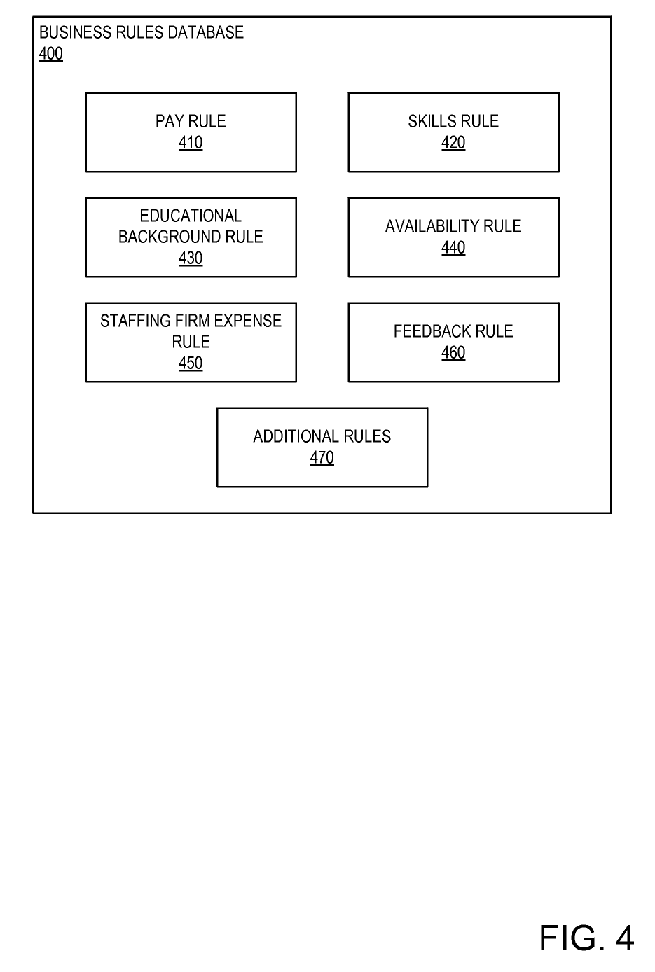

FIG. 4 shows a block diagram of an exemplary business rules database 400. In some embodiments, eligible applicants can be ranked according to one or more of the business rules shown in the business rules database 400.

A pay rule 410 can determine a score that reflects how well an applicant's desired pay information matches the offered pay information for the job. In one embodiment, the pay rule 410 can assign a pay score of 100 points to the applicant if the applicant's desired pay is less than or equal to the offered pay rate (or maximum offered pay rate if offered pay is provided as a pay range). For every 10% an applicant's desired pay exceeds the offered job pay, the pay score is reduced by 10 points.

A skills rule 420 can determine a score that reflects how well an applicant's skills information matches the desired skills information for the job. In one embodiment, the skills rule 420 can give an applicant a skills score of 100 points if the number of years of experience an applicant has for a job skill is within 10% of the desired number of years of experience indicated (or within 10% of the minimum years of experience, if a range of years is specified) in the job skills information. The skills score can be reduced by 10 points for each 10% the number of years the applicant's experience is below the number of years of experience specified in the job skills information. A skill score of zero is assigned if the applicant does not possess a particular indicated job skill. In some embodiments, if the job skills information specifies more than one job skill, a score can be determined for the individual skills, such that the sum of the skill scores does not exceed 100 points. The individual skills can be weighted equally or differently.

An educational background rule 430 can determine a score that reflects whether an applicant's educational background matches an employer's desired educational background for an applicant. In one embodiment, the educational background rule 430 can assign a degree score of 100 to the applicant if the applicant possesses the desired degree(s) and a score of zero if the applicant does not possess the desired degrees. In some embodiments, if multiple degrees are desired, the degree rule can assign a partial score if the applicant has earned fewer than all of the specified degrees.

An availability rule 440 can determine an availability score that reflects how well an applicant's availability information matches the job availability information. In one embodiment, the availability rule 440 can assign an availability score of 100 to the applicant if the applicant is available by the desired start date specified in the job information, a score of 60 if the applicant is available within five days of the desired start date, and a score of zero if the applicant is available later.

A staffing firm expense rule 450 can determine a staffing firm expense score based on staffing firm expense information. In one embodiment, a staffing firm expense rule 450 can assign a staffing firm expense score of 100 if the staffing firm is making either workers' compensation payments or unemployment insurance payments to an applicant. If a staffing firm is making both types of payments to an applicant, the staffing firm expense score can be set to 200. The staffing firm should take steps to ensure that ranking applicants based on whether an applicant is receiving workers' compensation or unemployment insurance payments, or has collected such payments in the past is legally allowed.

A feedback rule 460 can determine whether an employer does not want to hire an applicant or whether an applicant does not want to work for an employer, based on employer or applicant feedback information. If either party does not want to be matched, the feedback rule can be configured to not rank the applicant. The rank response can include information indicating which applicants, if any, were included in the rank request but not ranked. In some embodiments, if an eligible applicant went unranked because an employer indicated they did not want to hire the applicant, and the applicant would have otherwise been highly ranked (e.g., ranked first, within the top n applicants) the employer can be notified of the identity of such applicants, thereby providing the employer an opportunity to reconsider whether they do not want to work with the applicant, and update their applicant feedback information, either for that particular job, or for the employer in general.

Additional business rules 470 in addition to those listed above can be used in ranking eligible applicants for a job. The business rules discussed above are only exemplary embodiments, and it is to be understood that any algorithm that accepts as input the account information parameters and job information parameters associated with the business rule could be used to implement the business rule. For instance, maximum scores other than 100 points could be used for any of the business rules. Different business rules could have different maximum scores. For the pay (and skill) rules, the score can be reduced by amounts other than 10% for every increment that the desired pay rate (years of skill experience) exceeds the offered pay rate (desired years of experience), and the pay score (skill score) can be reduced at increments other than 10% by which the desired pay (years of applicant experience) exceeds the offered pay (desired years of experience). The pay and skill rules can award higher scores if the applicant has a desired pay that is less than the offered pay, or the number of years of experience is greater than that desired by the applicant.

### Example 6

### Exemplary Business Rules Weights

In any of the embodiments described herein, the business rules can have associated business rule weights. The business rule weights can be stored in the business rule database or elsewhere and can be made configurable. In some embodiments, the business rule weights can be determined by the decision making tool based on job and applicant information supplied in the rank request. For example, if the job skills information indicates that a skill is required or optional for a job, the job skill score weight could be increased or decreased, respectively. A weight for the degree score could be similarly increased or decreased based on how important it is to the employer that the applicant possesses the specified degrees. Weights for other business rules could be similarly modified depending on information supplied in a rank request. In some embodiments, the rank request can expressly specify the business rule weights. The business rule weights can be part of the applicant information, for example, if jobs are being ranked for an applicant, or part of the job information, for example, if applicants are being ranked for a job.

In one embodiment, eligible applicants are ranked based on the following business rule scores and weights: pay score (35%), skills score (25%), educational background score (10%), availability score (10%) staffing firm expense score (10% for workers' compensation-related expenses, 10% for unemployment score).

The business rule weights can be modified to achieve various objectives. For example, a staffing firm expenses weight can be increased in order to raise the rankings of applicants to which the staffing firm is currently making workers' compensation or unemployment insurance payments in order to increase staffing firm profit. In another example, the weights of the job skills and educational background scores could be increased, and the pay score weight decreased to raise the rankings of applicants who are perhaps more qualified for the job. Business rule weights can be modified to achieve other objectives.

### Example 7

### Exemplary Method of Ranking Applicants for a Job

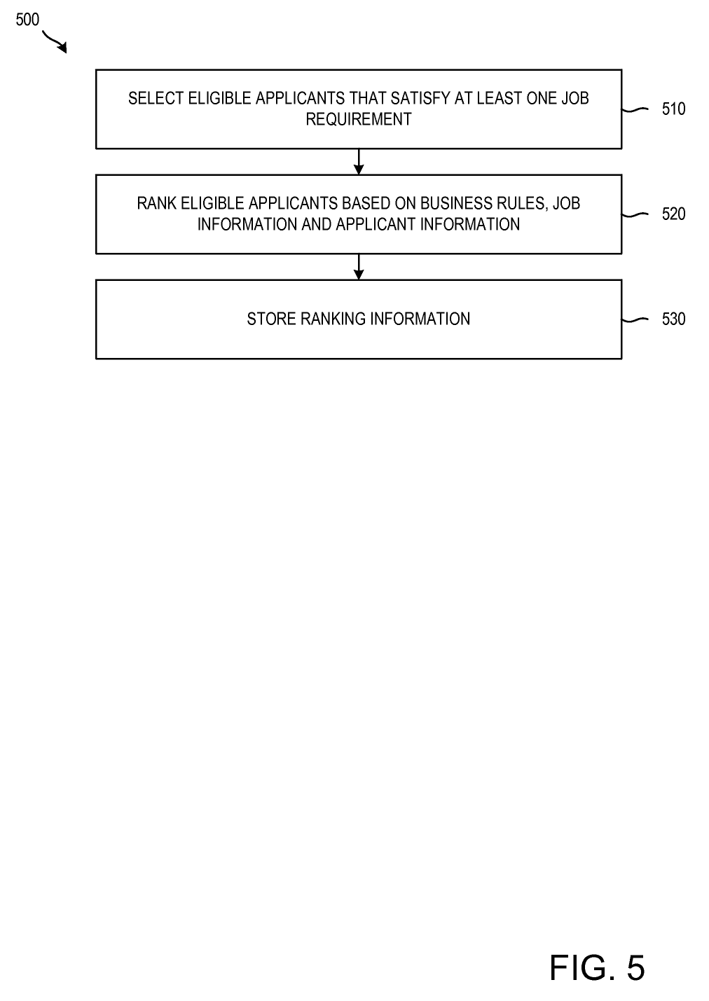

FIG. 5 is a flowchart of an exemplary method 500 of ranking applicants for a job.

At 510, a plurality of eligible applicants is selected from a plurality of applicants. The eligible applicants have associated applicant information that satisfies at least one job parameter that is part of job information associated with the job.

At 520, the plurality of eligible applicants are ranked, using a computer system, based at least in part on a plurality of business rules that uses at least a portion of the job information and at least a portion of the applicant information associated with the eligible applicants, thereby generating ranking information indicating a ranking for the eligible applicants.

At 530, the ranking information is stored.

Alternatively, the eligible applicants can have already been selected from a pool of applicants, or the ranking can be performed on all of the applicants, not just the selected eligible applicants.

The method 500 can include optional additional steps such as presenting at least a portion of the eligible applicants at an output device (such as at a display or printer) in an order based on the ranking information, and receiving the job information. In some embodiments, selecting and ranking the eligible applicants occurs in response to receiving the job information. That is, a ranking system can be configured to rank applicants for a job automatically upon receipt of a job order from an employer.

The method 500 can optionally further include sending one or more of the highest ranked applicants to an employer for the employer to provide feedback to the staffing firm on which applicant or applicants they are interested in hiring.

In some embodiments, the selecting of eligible applicants can comprise, if the number of eligible applicants exceeds a threshold, selecting the plurality of eligible applicants one or more additional times until the number of eligible applicants is below the threshold, the eligible applicants selected in the one or more additional selections satisfying at least one more job information parameter than the eligible applicants selected in the prior selection.

### Example 8

### Exemplary Method of Ranking of Eligible Applicants

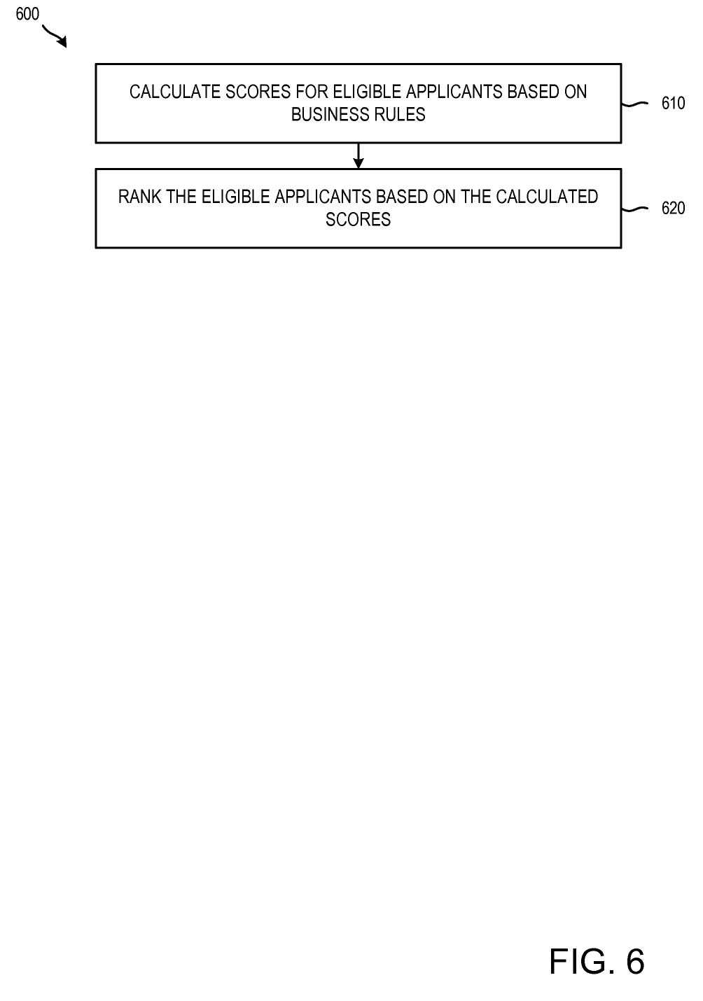

FIG. 6 is a flowchart of additional exemplary actions 600 that can comprise the ranking action 520 of the exemplary method 500 shown in FIG. 5.

At 610, scores are calculated for respective of the eligible applicants based on the business rules. Calculating the scores comprises applying one or more of the business rules to the applicant information associated with the respective eligible applicant and the job information to generate a plurality of business rules scores. The calculated scores are based on the plurality of business rules scores.

At 620, the eligible applicants are ranked based on the calculated scores. The ranking of eligible applicants is further based on weights associated with the business rule scores.

### Example 9

### Exemplary Presentation of Ranking Information

In any of the examples described herein, the FOSS 110 can present a list of eligible applicants in an order based on ranking information received from the decision making tool 120. The list can be presented at an output of the FOSS 110 (e.g., display, printer) or at an output of a device connected to the FOSS 110 via a network, such as a LAN or the Internet. The FOSS 110 can present all or a portion of the ranked eligible applicants in response to receiving a rank response 190. For example, a FOSS 110 can display a list of all of the eligible applicants for a job in ranked order, the highest ranked applicant, or the several highest ranked applicants. The ranked list of applicants can include all or a portion of the applicant information associated with the eligible applicants. The FOSS 110 can store the ranking information in a ranking information database 198.

The presented list can be used by staffing firm personnel to select an eligible applicant for the job. In some embodiments, ranking information can be sent directly to the employer offering the job for which the applicants were ranked.

### Example 10

### Exemplary Ranking of Eligible Jobs for an Applicant

In addition to ranking applicants for a job, the technologies described herein can be used to rank jobs for an applicant. For example, the ranking system 100 can be configured such that the matching module 130 can select eligible jobs for an applicant. The matching module can be configured to determine eligible jobs for an applicant based on matches between job information for a plurality of jobs and applicant information for a particular applicant. For example, eligible jobs can be selected based on matches on educational background, availability, skills, pay or any combination thereof. A rank request 180 from a FOSS 110 to a decision making tool 120 can include applicant information for an applicant and job information for the eligible jobs.

The decision making tool 120 can be configured to apply one or more business rules to the received applicant information and job information to calculate a score for the eligible jobs from which the eligible jobs can be ranked for the applicant. A rank response 190 can comprise ranking information indicating a ranking for the eligible jobs. The business rules used to calculate scores for the jobs can include any of the business rules described herein, or other business rules. The business rules used for calculating scores for eligible jobs can be weighted as well.

Additional business rules can be used that are specific for ranking jobs for an applicant, such as a business rule that assigns a score based on whether an employer pays their bills on time, thus potentially giving lower rankings to employers that are delinquent in paying their bills to the staffing firm. In this manner, the staffing firm can reduce its risk of not being paid, by making it less likely than an applicant is matched to an employer known not to pay their bills on time. Any additional ranking features described herein with regards to selecting eligible applicants and ranking eligible applicants for a job can be extended to selecting of eligible jobs and ranking of eligible jobs for an applicant.

### Example 11

### Exemplary Method of Ranking of Eligible Jobs for an Applicant

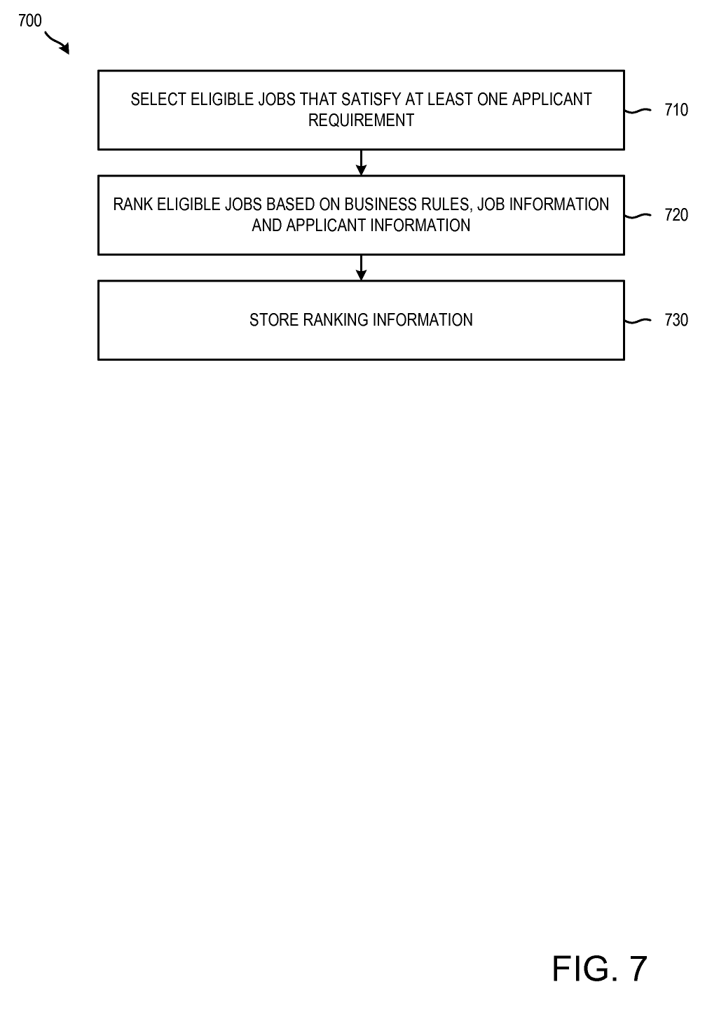

FIG. 7 is a flowchart of an exemplary method 700 for ranking jobs for an applicant.

At 710, a plurality of eligible jobs is selected from a plurality of jobs. The eligible jobs have associated job information that satisfies at least one applicant parameter that is part of applicant information associated with the applicant.

At 720, the plurality of eligible jobs are ranked, using a computer system, based at least in part on a plurality of business rules that uses at least a portion of the job information and at least a portion of the applicant information associated with the eligible jobs, thereby generating ranking information indicating a ranking for the eligible jobs.

At 730, the ranking information is stored.

Alternatively, the eligible jobs can already have been selected from a pool of jobs, or the ranking can be performed on all of the jobs, not just the selected eligible jobs.

The method 700 can optionally include additional steps such as presenting at least a portion of the eligible jobs at an output device (such as a display or printer) in an order based on the ranking information, and receiving the applicant information. In some embodiments, the selecting the eligible jobs and ranking the eligible jobs occurs in response to the receiving applicant information.

### Example 12

### First Applicant Ranking Scenario

Table 1 shows applicant information and job information for a first applicant ranking scenario. In the exemplary first through sixth ranking scenarios described in Examples 12 through 17, the ranking is performed using the business rules described in Example 5 and the business rule score weights described in Example 6: pay rate score (35%), skills score (25%) educational background score (10%), availability score (10%) staffing firm expense score (10% for workers' compensation-related expenses, 10% for unemployment score).

TABLE 1

| Job | Job | Applicant | Applicant | Applicant |
|---|---|---|---|---|
| Information | Information | Information | Information | Information |
| Parameter | Value | Parameter | Value | Value |
| Order ID | 0042 | Applicant ID | A | B |
| Branch | CA001 | Customer Feedback | Yes | Yes |
| Order Type | Temporary | Applicant Feedback | Yes | Yes |
| Order line | 1 | Worker | No | No |
| | | Compensation | | |
| Customer ID | 0000050038 | Unemployment | No | No |
| | | Insurance | | |
| Offered Pay Rate | 50-85 | Desired Pay Rate | 55 | 90 |
| (Min-Max, $/hr.) | | ($/hr.) | | |
| Desired Start Date | Aug. 2, 2011 | Start Date | Aug. 2, 2011 | Aug. 2, 2011 |
| Desired | Bachelor Of | Educational | Bachelor Of | Bachelor Of |
| Educational | Science- | Background | Science- | Science- |
| Background | Computer | | Computer | Computer |
| | Science | | Science | Science |
| | Bachelor Of | | Bachelor Of | Bachelor Of |
| | Science- | | Science- | Science- |
| | Management | | Management | Management |
| | Information | | Information | Information |
| | System | | System | System |
| Desired Skills | Data Base | Applicant Skills | Data Base | Data Base |
| | Design- | | Design- | Design- |
| | 1 years | | 1 years | 3 years |
| | Data Base | | Data Base | Data Base |
| | Administrator- | | Administrator- | Administrator- |
| | 3 years | | 3 years | 3 years |

In this first scenario, the applicants' educational background meets the employer's desired educational background. Applicant B is the more experienced applicant with two more years of data base administrator experience, but desires a pay rate greater than the offered pay rate. As the pay score for the applicants is the same (the pay business rule in this embodiment does not award extra points for having more experience than desired by the employer), applicant A is ranked first as applicant A desires pay within the offered pay rate range.

Thus, in this first exemplary scenario, the staffing firm realizes greater revenue by ranking applicant A ahead of applicant B. For example, if the job is for sixty days, and the maximum wage that the staffing firm can pay to an applicant and still earn a profit is $95/hr., then the staffing firm saves $16,800 in revenue by choosing applicant A for the job instead of applicant B. Table 2 shows the total revenue generated for the staffing firm in matching applicant A or B for the job is $19,200 ($95-$55×60 days×8 hrs./day=$19,200) and $2,400 ($95−$90×60 days×8 hrs./day=$2,400), respectively.

TABLE 2

| | Bill Rate | Pay Rate | | Revenue |
|---|---|---|---|---|
| Applicant | $/hr. | $/hr. | Duration | Generated $ |
| A | 95 | 55 | 60 days @ 8 hrs/day | 19,200 |
| B | 95 | 90 | 60 days @ 8 hrs/day | 2,400 |

### Example 13

### Second Applicant Ranking Scenario

Table 3 shows applicant information and job information for a second applicant ranking scenario.

TABLE 3

| Job | Job | Applicant | Applicant | Applicant |
|---|---|---|---|---|
| Information | information | information | Information | Information |
| Parameter | value | parameter | Value | Value |
| Order ID | 0042 | Applicant ID | A | B |
| Branch | CA001 | Customer Feedback | Yes | Yes |
| Order Type | Temporary | Applicant Feedback | Yes | Yes |
| Order line | 1 | Worker | No | No |
| | | Compensation | | |
| Customer ID | 0000050038 | Unemployment | No | No |
| | | Insurance | | |
| Offered Pay Rate | 50-85 | Desired Pay Rate | 65 | 65 |
| (Min-Max, $/hr.) | | ($/hr.) | | |
| Desired Start Date | Aug. 2, 2011 | Start Date | Aug. 2, 2011 | Aug. 2, 2011 |
| Desired | Bachelor Of | Educational | Bachelor Of | Bachelor Of |
| Educational | Science- | Background | Science- | Science- |
| Background | Computer | | Computer | Computer |
| | science | | science | science |
| | Bachelor Of | | Bachelor Of | Bachelor Of |
| | Science- | | Science- | Science- |
| | Management | | Management | Management |
| | Information | | Information | Information |
| | System | | System | System |
| Desired Skills | Data Base | Applicant Skills | Data Base | Data Base |
| | Design- | | Design- | Design- |
| | 1 years | | 1 years | 3 years |
| | Data Base | | Data Base | Data Base |
| | Administrator- | | Administrator- | Administrator- |
| | 3 years | | 3 years | 3 years |

The applicant information in this second scenario is the same as that in the first scenario, but with Applicant B's desired pay rate lowered from $90/hr. to $65/hr. If, as in this embodiment, the skills business rule does not award a higher score to an applicant that has more experience that the desired skills for the job, applicants A and B have the same score. In this instance, a rank response can indicate that the two applicants are ranked equally, or the decision making tool can break the tie by awarding the higher ranking to the more qualified applicant, here, applicant B.

### Example 14

### Third Applicant Ranking Scenario

Table 4 shows applicant information and job information for a third applicant ranking scenario.

TABLE 4

| Job | Job | Applicant | Applicant | Applicant |
|---|---|---|---|---|
| Information | information | information | Information | Information |
| Parameter | value | parameter | Value | Value |
| Order ID | 0042 | Applicant ID | A | C |
| Branch | CA001 | Customer Feedback | Yes | Yes |
| Order Type | Temporary | Applicant Feedback | Yes | Yes |
| Order line | 1 | Worker | No | No |
| | | Compensation | | |
| Customer ID | 0000050038 | Unemployment | No | No |
| | | Insurance | | |
| Offered Pay Rate | 50-85 | Desired Pay Rate | 65 | 65 |
| (Min-Max, $/hr.) | | ($/hr.) | | |
| Desired Start Date | Aug. 2, 2011 | Start Date | Aug. 2, 2011 | Aug. 2, 2011 |
| Desired | Bachelor Of | Educational | Bachelor Of | N/A |
| Educational | Science- | Background | Science- | |
| Background | Computer | | Computer | |
| | science | | science | |
| | Bachelor Of | | Bachelor Of | Bachelor Of |
| | Science- | | Science- | Science- |
| | Management | | Management | Management |
| | Information | | Information | Information |
| | System | | System | System |
| Desired Skills | Data Base | Applicant Skills | Data Base | Data Base |
| | Design- | | Design- | Design- |
| | 1 years | | 1 years | 1 years |
| | Data Base | | Data Base | Data Base |
| | Administrator- | | Administrator- | Administrator- |
| | 3 years | | 3 years | 3 years |

In this third scenario, applicant information for an applicant C is introduced. Applicant C's applicant information matches that of applicant A, except that applicant C does not have the desired educational background (applicant C lacks a computer science degree). Thus, in this scenario, applicant A is ranked second and applicant C is ranked third. Applicant B is ranked first as applicant B satisfies the job parameters and is more experienced than applicant A.

### Example 15

### Fourth Applicant Ranking Scenario

Table 5 shows applicant information and job information for a fourth applicant ranking scenario.

TABLE 5

| Job | Job | Applicant | Applicant | Applicant |
|---|---|---|---|---|
| Information | information | information | Information | Information |
| Parameter | value | parameter | Value | Value |
| Order id | 0042 | Applicant ID | A | B |
| Branch | CA001 | Customer Feedback | Yes | Yes |
| Order Type | Temporary | Applicant Feedback | Yes | Yes |
| Order line | 1 | Worker | No | No |
| | | Compensation | | |
| Customer ID | 0000050038 | Unemployment | No | No |
| | | Insurance | | |
| Offered Pay Rate | 50-85 | Desired Pay Rate | 65 | 65 |
| (Min-Max, $/hr.) | | ($/hr.) | | |
| Desired Start Date | Aug. 2, 2011 | Start Date | Aug. 2, 2011 | Aug. 31, 2011 |
| Desired | Bachelor Of | Educational | Bachelor Of | Bachelor Of |
| Educational | Science- | Background | Science- | Science- |
| Background | Computer | | Computer | Computer |
| | science | | science | science |
| | Bachelor Of | | Bachelor Of | Bachelor Of |
| | Science- | | Science- | Science- |
| | Management | | Management | Management |
| | Information | | Information | Information |
| | System | | System | System |
| Desired Skills | Data Base | Applicant Skills | Data Base | Data Base |
| | Design- | | Design- | Design- |
| | 1 years | | 1 years | 3 years |
| | Data Base | | Data Base | Data Base |
| | Administrator- | | Administrator- | Administrator- |
| | 3 years | | 3 years | 3 years |

In this fourth scenario, applicants A and B have the same applicant information except that applicant B is available to start working several weeks after the desired start date. Thus, applicant A is ranked ahead of applicant B.

### Example 16

### Fifth Applicant Ranking Scenario

Table 6 shows applicant information and job information for a fifth applicant ranking scenario.

TABLE 6

| Job | Job | Applicant | Applicant | Applicant |
|---|---|---|---|---|
| Information | information | information | Information | Information |
| Parameter | value | parameter | Value | Value |
| Order id | 0042 | Applicant ID | D | E |
| Branch | CA001 | Customer Feedback | Yes | Yes |
| Order Type | Temporary | Applicant Feedback | Yes | Yes |
| Order line | 1 | Worker | No | Yes |
| | | Compensation | | |
| Customer ID | 0000050038 | Unemployment | Yes | No |
| | | Insurance | | |
| Offered Pay Rate | 50-85 | Desired Pay Rate | 85 | 73 |
| (Min-Max, $/hr.) | | ($/hr.) | | |
| Start Date | Aug. 2, 2011 | Start Date | Aug. 2, 2011 | Aug. 2, 2011 |
| Desired | Bachelor Of | Educational | N/A | N/A |
| Educational | Science- | Background | | |
| Background | Computer | | | |
| | science | | | |
| | Bachelor Of | | N/A | N/A |
| | Science- | | | |
| | Management | | | |
| | Information | | | |
| | System | | | |
| Desired Skills | Data Base | Applicant Skills | Data Base | Data Base |
| | Design- | | Design- | Design - |
| | 1 years | | 1 years | 3 years |
| | Data Base | | N/A | Product |
| | Administrator- | | | Management - |
| | 3 years | | | 5 years |

In this fifth scenario, the applicant information for two new applicants, applicants D and E are added. Applicants D and E have the same staffing firm expense score because applicants D and E are either collecting workers' compensation or are collecting unemployment insurance. Applicant D is ranked fourth, ahead of applicant E, as applicant D has more experience than applicant E does. Applicants D and E are ranked below applicants A, B and C because applicants D and E lack the desired educational background and desired skills (neither have data base administrator experience). Thus, even though a staffing firm can attempt to reduce its expenses by matching a job with an applicant to whom the firm is paying unemployment insurance or workers' compensation, these applicants are not necessarily always rated the highest.

### Example 17

### Sixth Applicant Ranking Scenario

Table 7 shows applicant information and job information for a sixth applicant ranking scenario.

TABLE 7

| Job | Job | Applicant | Applicant |
|---|---|---|---|
| Information | Information | information | Information |
| Parameter | value | parameter | Value |
| Order ID | 0042 | Applicant ID | A |
| Branch | CA001 | Customer Feedback | Yes |
| Order Type | Staffing | Applicant Feedback | No |
| | Temporary | | |
| | order | | |
| Order line | 1 | Worker | No |
| | | Compensation | |
| Customer ID | 0000050038 | Unemployment | No |
| | | Insurance | |
| Offered Pay Rate | 50-85 | Desired Pay Rate | 55 |
| (Min-Max, $/hr.) | | ($/hr.) | |
| Start Date | Aug. 2, 2011 | Start Date | Aug. 2, 2011 |
| Desired | Bachelor Of | Educational | Bachelor Of |
| Educational | Science- | Background | Science- |
| Background | Computer | | Computer |
| | science | | science |
| | Bachelor Of | | Bachelor Of |
| | Science- | | Science- |
| | Management | | Management |
| | Information | | Information |
| | System | | System |
| Desired Skills | Data Base | Applicant Skills | Data Base |
| | Design- | | Design- |
| | 1 years | | 1 years |
| | Data Base | | Data Base |
| | Administrator- | | Administrator- |
| | 3 years | | 3 years |

In this sixth scenario, the applicant information for Applicant A indicates that the applicant is not interested in working for the employer associated with customer ID 50038. By not including applicant A in the rankings for the job, the staffing firm does not attempt to match the job to an applicant that is not interested in working for that particular employer.

### Example 18

### Exemplary Employer/Applicant Feedback

In any of the examples described herein, the decision making tool can be configured to analyze ranking information and generate feedback that can be supplied to an applicant or an employer to enable better matches. For example, the decision making tool can be configured to determine which parameters in a particular applicant's applicant information could result in the applicant being chosen as an eligible applicant more often or to be ranked higher when selected as an eligible applicant. For example, as part of ranking eligible applicants for a job, the decision making tool can determine, for the respective applicants, what changes in the applicant's desired pay, skills, educational background, and availability could be changed to move him or her into the top several applicants for the job. For instance, feedback to the applicant could comprise a suggestion that the applicant lower his or her desired pay, pursue a degree, or offer to be more available.

The decision making tool can be configured to keep track of recent rankings for an applicant, and, after a certain number of times the applicant is included as an eligible applicant (e.g., 5, 10 or 20 times), determine feedback to be provided to the applicant if the applicant is consistently ranked low (e.g., on average the applicant is ranked in bottom one-half, one-third, one-tenth). The tool can then review the ranking information of earlier rankings involving the applicant to determine which applicant information parameters, if changed, would have resulted in the applicant being ranked higher (e.g., in the top-half, top-third, top-tenth). In a similar manner, the tool can generate applicant feedback suggesting that the applicant be willing to work for an employer that the applicant has indicated he is not willing to work for, if that employer has had many job postings, and the applicant is not being frequently selected for other jobs.

In a similar manner, employer feedback can be generated, if, for example, applicants whose educational background and/or skills match what an employer is looking for, are being consistently ranked low for that employer. For example, if, after a certain number of rankings involving an employer, the best match for the job in terms of skills and educational background is not a top-ranked applicant (e.g., the highest ranked, within the top n applicants), the tool can determine what parameters in the job information, if changed, would have resulted the highest qualified applicant to be the highest ranked applicant. For example, the feedback can suggest that the employer offer a higher pay rate to attract the top applicants, or offer more flexible employment windows. In a similar fashion, the tool could provide feedback to an employer if a small number or no applicants are deemed eligible. In this case, feedback to the employer can comprise suggesting, for example, that the employer lower their skills or educational background qualifications.

In some embodiments, the decision making tool can be configured to gradually learn about the staffing business, so that questions about the staffing enterprise can be answered, such as when a filled job order can be expected to be paid by an employer, and should the staffing firm charge a fee for an employer that does not pay their bills on time. Additional questions can be answered such as what applicant information parameters lead to a filled order, and are job boards effective at filling vacancies.

### Example 19

### Exemplary Ranking System Embodiment Using Oracle® PeopleSoft® Software and Oracle® Real Time Decision (RTD) Platform

In one embodiment, applicants can be ranked with a ranking system that employs the PeopleSoft® software and Real Time Decision (RTD) platform provided by Oracle®. For example, in the ranking system 100 in FIG. 1, the FOSS system 110 can comprise PeopleSoft® software and the decision making tool 120 can comprise the RTD platform.

The PeopleSoft® software and RTD platform can be integrated, in one example, as follows. The PeopleSoft® Staffing Front Office software can receive applicant information, job information via one or more external channels, such as employer portals, applicant portals, job boards and the like. The portals can be web-based whereby applicant or job information is provided via a website, or entered at computers that are connected to the PeopleSoft® software via a network connection. The PeopleSoft® Front Office then selects eligible applicants from a pool of applicants for a job. A rank request comprising eligible applicant information and job information is sent from PeopleSoft® to the RTD platform via a PeopleSoft® request message sent using the PeopleSoft® Integration Broker. Business rules are configured at the RTD platform depending on a staffing firm's business needs.

Based on the business rules and the information contained in the rank request, the RTD platform ranks the eligible applicants for the job in real-time. That is, the RTD platform performs the ranking operation in response to the receiving the rank request. After ranking the eligible applicants, the RTD platform sends a rank response to the PeopleSoft® application comprising ranking information about the eligible applicants. The PeopleSoft® application displays the eligible applicants in ranked order on a People Match page, allowing a staffing firm applicant to select a best applicant for a job assignment. The integrated PeopleSoft®-RTD platform system can be used to perform other staffing-related ranking functions such as ranking eligible jobs for applicant as described herein.

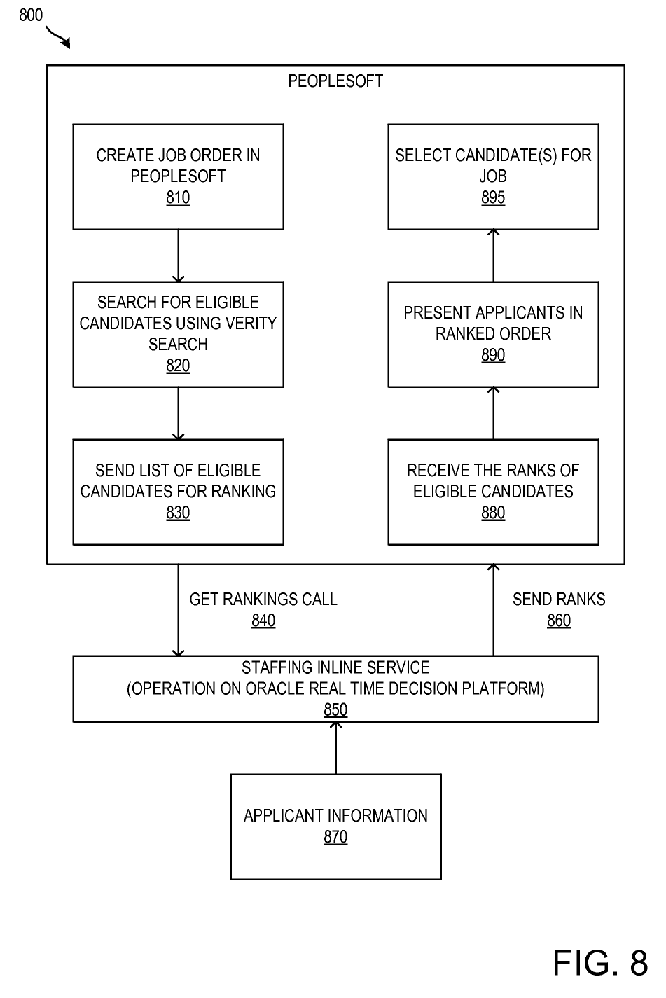

FIG. 8 shows a block diagram of a workflow 800 utilizing Oracle®'s PeopleSoft® and RTD platform. At 810, an employer creates a job order in PeopleSoft®. The job order comprises job information, as described herein. At 820, PeopleSoft® searches for eligible applicants using the PeopleSoft® Verity Search Engine. At 830, PeopleSoft® sends a list of the eligible applicants for ranking to the Oracle® RTD platform using PeopleSoft® message via the PeopleSoft® Integration Broker. The list can be sent as part of a call 840 that calls a Staffing Inline Service 850 implemented in the RTD Platform. The Staffing Inline Service ranks the eligible applicants and sends the ranks to PeopleSoft® by sending a ranking response 860. The RTD platform ranks the applicants by determining scores for business rules and information supplied in the rank request. The business rules are configured at the RTD platform depending on business needs of the staffing firm, employer or applicant. The RTD platform reads any additional applicant information needed from an applicant database 870. At 880, PeopleSoft® receives the rankings of eligible applicants. At 890, PeopleSoft® presents the eligible applicants in a ranked order. At 895, a staffing firm employee can select an applicant for the job.

### Example 20

### Exemplary Utility of Staffing Ranking Systems

The tools and technologies described provide at least the following exemplary advantages. Eligible applicants can be ranked in real-time, thereby allowing a staffing firm to quickly provide qualified applicants to their employer customers. An applicant's expenses to a staffing firm, such as whether they are being paid workers' compensation or unemployment insurance, can be considered when ranking eligible applicants, which can potentially increase staffing firm profits. The business rules weights that can form part of the basis of ranking applicants can be tailored to achieve other objectives as well. For example, the objective of matching the most qualified applicants to a job can be implemented by increasing the weight of the educational background and skills scores. Further, by accounting for employer and applicant feedback indicating which applicants an employer does not wish to employ, and which employers an applicant does not wish to work for, the staffing firm can reduce the number of suggested matches in which that applicants or employers are not interested. By offering good matches in a timely manner to both employers and applicants, staffing firm customers are more likely to be satisfied, which can result in repeat business.

### Example 21

### Exemplary Computing Environment

The techniques and solutions described herein can be performed by software and/or hardware of a computing environment, such as a computing device. Exemplary computing devices include server computers, desktop computers, laptop computers, notebook computers, netbooks, tablet devices, mobile devices, smartphones and other types of computing devices.

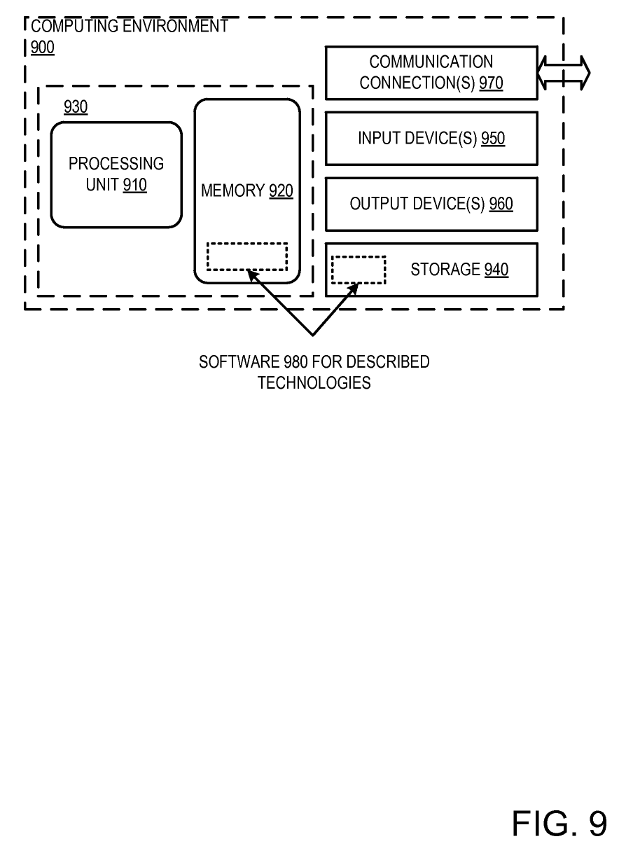

FIG. 9 illustrates a generalized example of a suitable computing environment 900 in which described embodiments, techniques, and technologies can be implemented. The computing environment 900 is not intended to suggest any limitation as to scope of use or functionality of the technology, as the technology can be implemented in diverse general-purpose or special-purpose computing environments. For example, the disclosed technology can be implemented using one or more computing devices (e.g., a server, desktop, laptop, hand-held device, mobile device, smartphone), respective of the computing devices comprising a processing unit, memory and storage storing computer-executable instructions implementing the technologies described herein. The disclosed technology can also be implemented with other computer system configurations, including multiprocessor systems, microprocessor-based or programmable consumer electronics, network PCs, minicomputers, mainframe computers, a collection of client/server systems and the like. The disclosed technology can also be practiced in distributed computing environments where tasks are performed by remote processing devices that are linked through a communications network, such as the Internet. In a distributed computing environment, program modules can be located in both local and remote memory storage devices.

With reference to FIG. 9, the computing environment 900 includes at least one central processing unit 910 and memory 920. In FIG. 9, this most basic configuration 930 is included within a dashed line. The central processing unit 910 executes computer-executable instructions. In a multi-processing system, multiple processing units execute computer-executable instructions to increase processing power and as such, multiple processors can be running simultaneously. The memory 920 can be volatile memory (e.g., registers, cache, RAM), non-volatile memory (e.g., ROM, EEPROM, flash memory, etc.), or some combination of the two. The memory 920 stores software 980 that can, for example, implement the technologies described herein. A computing environment can have additional features. For example, the computing environment 900 includes storage 940, one or more input devices 950, one or more output devices 960 and one or more communication connections 970. An interconnection mechanism (not shown) such as a bus, a controller, or a network, interconnects the components of the computing environment 900. Typically, operating system software (not shown) provides an operating environment for other software executing in the computing environment 900, and coordinates activities of the components of the computing environment 900.

The storage 940 can be removable or non-removable, and includes magnetic disks, magnetic tapes or cassettes, CD-ROMs, CD-RWs, DVDs, or any other tangible storage medium which can be used to store information and which can be accessed within the computing environment 900. The storage 940 stores instructions for the software 980, which can implement technologies described herein.

The input device(s) 950 can be a touch input device, such as a keyboard, keypad, mouse, touchscreen, pen, or trackball, a voice input device, a scanning device, or another device, that provides input to the computing environment 900. For audio, the input device(s) 950 can be a sound card or similar device that accepts audio input in analog or digital form, or a CD-ROM reader that provides audio samples to the computing environment 900. The output device(s) 960 can be a display, printer, speaker, CD-writer or another device that provides output from the computing environment 900.

The communication connection(s) 970 enable communication over a communication medium (e.g., a connecting network) to other computing entities. The communication medium conveys information such as computer-executable instructions, compressed graphics information or other data in a modulated data signal.

The computing environment 900 can comprise web-based services. For example, the job information or applicant information can be supplied by applicants or employers accessing a web page of a staffing firm. The web page can be accessed, for example, by a mobile device such as a laptop, tablet computer or smartphone, or non-mobile device such as a desktop.

### Cloud-Computing Environment

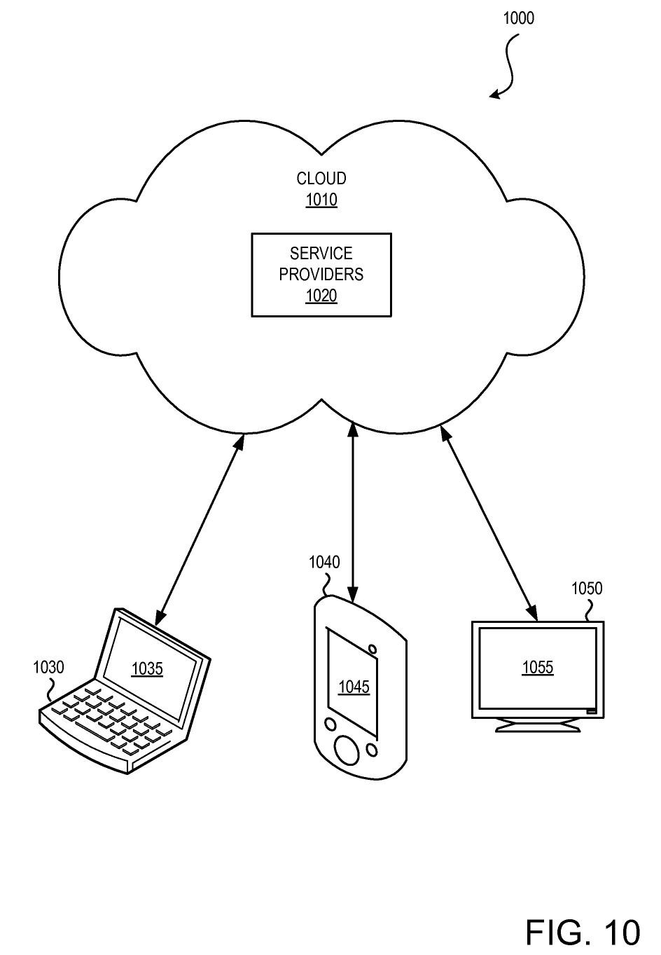

The techniques and solutions described herein can be performed in a cloud-computing environment. FIG. 10 illustrates a generalized example of a suitable implementation environment 1000 in which described embodiments, techniques, and technologies can be implemented.

In example environment 1000, various types of services (e.g., computing services) are provided by a cloud 1010. For example, the cloud 1010 can comprise a collection of computing devices, which can be located centrally or distributed, that provide cloud-based services to various types of users and devices connected via a network such as the Internet. The implementation environment 1000 can be used in different ways to accomplish computing tasks. For example, some tasks (e.g., processing user input, presenting a user interface, selecting eligible applicants or jobs) can be performed on local computing devices (e.g., connected devices 1030, 1040, 1050) while other tasks (e.g., storage of data to be used in subsequent processing, ranking of eligible applicants and jobs) can be performed in the cloud 1010.

In example environment 1000, the cloud 1010 provides services for connected devices 1030, 1040, 1050 with a variety of screen capabilities. Connected device 1030 represents a device with a computer screen (e.g., a mid-size screen 1035). For example, connected device 1030 could be a desktop, laptop, notebook, netbook or tablet computer or the like. Connected device 1040 represents a mobile computing device with a mobile computing device screen 1045 (e.g., a small-size screen). For example, connected device 1040 could be a mobile phone, smartphone, personal digital assistant or the like. Connected device 1050 represents a device with a large screen 1055. For example, connected device 1050 could be a television with Internet connectivity, or a television connected to another device capable of connecting to the cloud such as a set-top box, gaming console or the like. Devices without screen capabilities also can be used in example environment 1000. For example, the cloud 1010 can provide services for one or more computers (e.g., server computers) without displays.

Services can be provided by the cloud 1010 through service providers 1020, or through other providers of online services (not depicted). For example, cloud services can be customized to the screen size, display capability, and/or touch screen capability of a particular connected device (e.g., connected devices 1030, 1040, 1050). Services that can be provided by the service providers 1020 include, for example, email, Short Message Service (SMS), Multimedia Message Service (MMS), social networking and website hosting. The service providers can host online marketplaces offering wide varieties of goods and services such as software applications and upgrades and media content which can be obtained by users with or without purchase and for download from the cloud or delivery through postal mail. Service providers provide storage for information such as the job information database, the applicant information database or the business resource database.

In example environment 1000, the cloud 1010 provides the technologies and solutions described herein to the various connected devices 1030, 1040, 1050 using, at least in part, the service providers 1020. For example, the service providers 1020 can provide a centralized solution for various cloud-based services. The service providers 1020 can manage service subscriptions for users and devices (e.g., for the connected devices 1030, 1040, 1050 and their respective users).

### Methods in Computer-Readable Media

Any of the disclosed methods can be implemented as computer-executable instructions or a computer program product. The computer-executable instructions or computer program products as well as any data created and used during implementation of the disclosed embodiments can be stored on one or more computer-readable storage media (e.g., non-transitory computer-readable storage media, such as one or more optical media discs (such as DVDs or CDs), volatile memory components (such as DRAM or SRAM), or nonvolatile memory components (such as flash memory or hard drives)) and executed on a computer (e.g., any commercially available computer, including smart phones or other computing devices that include computing hardware). Computer-readable storage media does not include propagated signals. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are known in the art are omitted. For example, it is to be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

### DEFINITIONS

As used in this application and in the claims, the singular forms “a,” “an,” and “the” include the plural forms unless the context clearly dictates otherwise. Similarly, the word “or” is intended to include “and” unless the context clearly indicates otherwise. The term “comprising” means “including;” hence, “comprising A or B” means including A or B, as well as A and B together. Additionally, the term “includes” means “comprises.”

As used in this application, the term “applicant” refers to a job applicant, candidate or employee and includes those currently employed as well as those who are looking for employment.

As used in this application, the term “job” refers to full-time and part-time position offer by an employer for which an applicant is paid a wage. The wage can be a salary (the applicant is paid on a periodic basis), piece wages (the applicant is paid per unit produced or action performed), or any other type of wage.

Additionally, the description sometimes uses terms like “produce” and “provide” to describe the disclosed methods. These terms are high-level abstractions of the actual computer operations that are performed. The actual computer operations that correspond to these terms will vary depending on the particular implementation and are readily discernible by one of ordinary skill in the art.

### Alternatives

The disclosed methods, apparatuses and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation. In view of the many possible embodiments to which the principles of the illustrated embodiments may be applied, it should be recognized that the illustrated embodiments are only examples and should not be taken as limiting the scope of the disclosure. We claim all that comes within the scope of the appended claims.

We claim:

1. A method of ranking applicants for a job, the method comprising:
selecting a plurality of eligible applicants from a plurality of applicants, the eligible applicants having associated applicant information that satisfies at least one job information parameter that is part of job information associated with the job;
using a computer system, ranking the plurality of eligible applicants based at least in part on a plurality of business rules that uses at least a portion of the job information and at least a portion of the applicant information associated with the eligible applicants, thereby generating ranking information indicating a ranking for the eligible applicants; and
storing the ranking information.

2. The method of claim 1, further comprising presenting at least a portion of the eligible applicants at an output device of the computer system in an order based on the ranking information.

3. The method of claim 1, wherein the plurality of business rules have associated business rule weights, the ranking being further based on at least one of the business rule weights, at least one of the business rule weights being included in the job information.

4. The method of claim 1, wherein the applicant information comprises staffing firm expense information, the ranking being based at least in part on the staffing firm expense information for the eligible applicants.

5. The method of claim 4, wherein the staffing firm expense information includes workers' compensation information or unemployment insurance information.

6. The method of claim 1, wherein the applicant information for the eligible applicants comprises employer feedback information indicating that at least one of the eligible applicants is not willing to be employed by an employer offering the job.

7. The method of claim 6, wherein the ranking information does not include information indicating a ranking for the at least one of the eligible applicants.

8. The method of claim 1, wherein the job information comprises applicant feedback information indicating that an employer offering the job is not willing to hire at least one of the eligible applicants.

9. The method of claim 8, wherein the ranking information does not include information indicating a rank for the at least one applicants.

10. The method of claim 1, wherein the ranking comprises:
calculating scores for the eligible applicants based on the plurality of business rules, the calculating comprising applying one or more of the plurality of business rules to the applicant information associated with the eligible applicants and the job information, thereby generating a plurality of business rules scores, the calculated scores being based on the plurality of business rules scores, the job information, the applicant information associated with the eligible applicants, and a plurality of business rule weights associated with the plurality of business rules; and
ranking the eligible applicants based on the calculated scores.

11. The method of claim 1, wherein the ranking is performed by a decision making platform, the method further comprising, at the decision making platform:
receiving the job information and the applicant information for the eligible applicants from a front office staffing system (FOSS); and
sending the ranking information to the FOSS.

12. The method of claim 1, further comprising receiving the job information, wherein the selecting and the ranking occurs in response to the receiving the job information.

13. The method of claim 1, wherein one or more first eligible applicants are ranked ahead of a second eligible applicant, the method further comprising:
determining one or more applicant information parameters associated with the second eligible applicant that, if modified, would have caused the second eligible applicant to be ranked ahead of at least one of the one or more first eligible applicants; and
providing feedback to the second eligible applicant comprising a suggestion that the second eligible applicant change at least one of the one or more determined applicant information parameters.

14. The method of claim 1, wherein one or more first eligible applicants are ranked ahead of a second eligible applicant with more skills or more education that the one or more first eligible applicants, the method further comprising:
determining one or more job information parameters that, if modified, would have caused the second eligible applicant to be ranked ahead of at least one of the one or more first eligible applicants; and
providing feedback to an employer offering the job comprising a suggestion that the employer change at least one of the one or more job information parameters.

15. The method of claim 1, wherein the selecting comprises, if the number of eligible applicants exceeds a threshold, selecting the plurality of eligible applicants one or more additional times until the number of eligible applicants is below the threshold, the eligible applicants selected in the one or more additional selections satisfying at least one more job information parameter than the eligible applicants selected in the prior selection.

16. One or more computer-readable storage media storing computer-executable instructions for causing the computer system to perform the method of claim 1.

17. A method of ranking applicants for a job, the method comprising:
at a computer system, selecting a plurality of eligible applicants from a plurality of applicants, the eligible applicants having associated applicant information that satisfies at least one job information parameter that is part of job information associated with the job;
sending a rank request to a decision making tool, the rank request comprising at least a portion of the applicant information associated with the eligible candidates and at a portion of the job information;
receiving a rank response from the decision making tool, the rank response comprising ranking information indicating a ranking of at least a portion of the eligible applicants; and
presenting at least a portion of the eligible candidates at an output device of the computer system in an order based on the ranking information.

18. A method of ranking applicants for a job, the method comprising:
at a computer, receiving a rank request from a front office staffing system (FOSS), the rank request comprising applicant information associated with a plurality of eligible candidates and job information;
ranking the plurality of eligible applicants based at least in part on a plurality of business rules that uses at least a portion of the job information and at least a portion of the applicant information associated with the eligible applicants, thereby generating ranking information indicating a ranking for the eligible applicants; and
sending the ranking information to the FOSS.

19. A method of ranking jobs for an applicant, the method comprising:
selecting a plurality of eligible jobs from a plurality of jobs, the eligible jobs having associated job information that satisfies at least one applicant information parameter associated with the applicant;
using a computer system, ranking the plurality of eligible jobs based at least in part on a plurality of business rules that uses at least a portion of the applicant information and at least a portion of the job information associated with the eligible jobs, thereby generating ranking information indicating rankings for the eligible jobs; and
storing the ranking information.

20. A computer-implemented system, comprising:
a front office staffing system (FOSS);
a decision making tool;
one or more computer-readable media configured to cause the system to perform a method comprising:
at the FOSS, selecting a plurality of eligible applicants from a plurality of applicants, the eligible applicants having associated applicant information that satisfies at least one job information parameter that is part of job information associated with a job;
sending a rank request from the FOSS to the decision making tool, the rank request comprising applicant information for the eligible applicants and the job information;
at the decision making tool, ranking the plurality of eligible applicants based at least in part on a plurality of business rules that uses at least a portion of the job information received at the decision making tool and at least a portion of the applicant information associated with the eligible applicants received at the decision making tool, thereby generating ranking information indicating a ranking for the eligible applicants;
sending a rank response from the decision making tool to the FOSS comprising the ranking information; and
at the FOSS, presenting at an output device of the computer-implemented system, at least a portion of the eligible applicants in an order based on the ranking information.
